(19) United States
(12) Patent Application Publication
(10) Pub. No.: US 2008/0137160 A1
(43) Pub. Date: Jun. 12, 2008

(54) Security Holograms

(76) Inventor: John David Wiltshire, Cambridgeshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/814,469

(22) PCT Filed: Jan. 23, 2006
(86) PCT No.: PCT/GB2006/050016

§ 371 Date: Nov. 28, 2007

Related U.S. Application Data
(60) Provisional application No. 60/651,652, filed on Feb. 11, 2005.

(30) Foreign Application Priority Data
Jan. 21, 2005 (GB) 0501213.3

(51) Int. Cl. G03H 1/26; G03H 1/10

(52) U.S. Cl. 359/2; 359/22; 359/11

(57) ABSTRACT

This invention relates to improved holograms, in particular suitable for security applications, and to methods and apparatus for their fabrication. A hologram storing a pair of images, the hologram comprising: a first stored image configured to replay at a first wavelength; and a second stored image configured to replay at a second wavelength different to said first wavelength; and wherein said first and second stored images are spatially complementary such that when replayed they appear together, substantially in register, and give the appearance of a single, substantially uninterrupted image.

This invention relates to improved holograms, in particular suitable for security applications, and to methods and apparatus for their fabrication.

Holograms have many uses but one increasingly important application is that of security, where a hologram may be used as an anti-counterfeiting device on security documents such as passports, visas, identity cards, driver licences, government bonds, Bills of Exchange, banknotes and the like, as well as on packaging and labelling. To improve security special visual effects may sometimes be employed such as kinetic effects, for example the appearance/disappearance of graphic elements (sometimes termed Kinegram—Trade Mark), or contrast/brightness variation effects, for example a graphic converting from a positive to a negative image (a Pixelgram—Trade Mark).

It will be appreciated, however, that there is scope for improved holographic techniques which contribute to increased security or which exhibit other desirable traits such as increased brightness and/or an improved visually aesthetic appearance. Background information relating to improved techniques for multicolour reflection holograms can be found in Improved Techniques for Multicolour Reflection Holograms, P. Hariharan, 1980 J. Opt, 11, 53-55, which refers to advantages of recording different colours in separate plates so that when the plates are aligned a multicolour image is the result.

According to a first aspect of the present invention there is therefore provided a hologram storing a pair of images, the hologram comprising: a first stored image configured to replay at a first wavelength; and a second stored image configured to replay at a second wavelength different to said first wavelength; and wherein said first and second stored images are spatially complementary such that when replayed they appear together, substantially in register, and give the appearance of a single, substantially uninterrupted image.

In embodiments, storing two (or more) entry images so that they give the appearance of a single, substantially uniform/uninterrupted image facilitates the creation of an improved aesthetic appearance and in addition can significantly increase perceived brightness of the (replayed) hologram. This latter point can be understood, in simplistic terms, by considering that if a displayed image is half black the maximum overall diffraction efficiency of the hologram will be 50 percent, whereas if the image comprises a two tone image the different tones having different colours then, theoretically the diffraction efficiency can approach 100 percent (depending upon the illumination). To consider the effect on aesthetic appearance consider the example of a hologram of a fingerprint—this can look visually unexciting in “black and white” but is much more visually attractive if when, for example, the ridges are in one colour (say red) and the valleys in another, different colour (say green). Further advantages and benefits of embodiments of the invention, especially as applied to fingerprints are outlined later.

Preferably the first and second stored images are configured such that when they are replayed a region not occupied by one of the images is occupied by the other, and vice-versa. Thus preferably the first and second images are derived from a binarised version of the single, substantially uninterrupted image, one of the first and second images corresponding to a first binarised value of the single image, the other to a second binarised value of the single image. In this way the first and second images are complementary in that one of the first and second images is the binary inverse of the other.

Preferably the first and second images are both substantially planar, and preferably they both occupy substantially the same plane when replayed. Preferably there is substantially no angular separation between the first and second images, although the appearance of the images together may change with viewing angle. For example, typically the brightness of the single combined image will change with viewing angle although its two colours will preferably remain substantially the same. For colours in the yellow, where the eye is sensitive to small changes in wavelength, there may be a small colour shift in which case a colour may be defined as a colour at an image peak or central viewing angle (normally maximum brightness). Preferably the hologram comprises a volume reflection hologram.

The first and second wavelengths in which the first and second stored images are replayed may, but need not be visible. For example the first and second images could be recorded using, say, red and green lasers and then shifted by chemical processing so that one or other of the stored images is in the infrared or ultraviolet. The two different wavelengths need not necessarily define two different visually distinguishable colours (to a human) in embodiments there are advantages to a hologram which appears to have a single substantially uniform colour to a human but which in fact comprises complementary images at different wavelengths which can be distinguished by machine. Thus preferably the peak first and second wavelengths are resolvable by a machine reader and may be separated, for example, by at least a peak FWHM (Full Width Half Maximum). In practice this is not an onerous constraint since, for example, in the green region of the spectrum two different wavelengths 30 nm apart can appear to be substantially the same colour. For aesthetic reasons the first and second wavelengths may define complementary colours.

In other embodiments it is desirable for the first and second wavelengths to define different visually distinguishable (to a human being) colours. For example in the CIE (Commission de L′Eclarage) the difference between two colours ΔE can be described by:

ΔE=√((ΔL*)²+(Δa*)²+(Δb*)²)

where the L*, a* and b* values represent the lightness, red-to-green and blue-to-yellow values of the two colours (based upon the principle that the colour cannot be both red and green or blue and yellow). Broadly speaking a ΔE value of 1 is visible whereas a ΔE of 0.1 does not correspond to a visible colour difference (although ΔE does not exactly correspond to a visual assessment of a colour difference for all colours). In embodiments, however, the first and second wavelengths define colours with a CIE colour difference of <0.1, <0.5, or <1.0.

In some particularly preferred embodiments the single, substantially uninterrupted image comprises a biometric image such as an image of an iris or fingerprint. Reproduction of an image of a fingerprint in two visually different colours (or even at two wavelengths corresponding to substantially visually indistinguishable colours) provides increased security. This is because the pattern of ridges in a fingerprint is different to the pattern of valleys and the correct pattern must be matched (whichever this happens to be). By providing a hologram of a fingerprint in which the ridges and valleys have different, false colours it is more difficult for a counterfeiter to select the correct pattern, increasing the probability that the pattern of ridges instead of the pattern of valleys (or vice-versa) will be copied.

In a related aspect the invention provides a method of creating a hologram, in particular as claimed in any preceding claim, the method comprising: receiving an initial image; partitioning said initial image into two spatially complementary regions defining respective first and second images which, when displayed together, give substantially the appearance of said initial image; and writing said first and second images into a single hologram such that they replay at respective first and second wavelengths, said first and second wavelengths being different to one another, to create said hologram.

It will be appreciated that the initial image need not be a realistic image and may, for example, have been pre-processed. Any conventional holographic recording material may be employed including, but not limited to dichromated gelatine (DCG), silver halide, and photopolymer-based materials. After fabrication the hologram may be fastened to a substrate of any convenient material including, but not limited to, paper, plastic, glass, metal and the like; some particularly preferred methods for this are described in the applicant's co-pending UK Patent Application No. 0426571.6 filed on 3 Dec. 2004.

The writing of the hologram may comprise direct writing of one or both of the first and second images or a more conventional writing technique may be employed, writing the first image into the hologram at one laser wavelength and the second image into the hologram at a different laser wavelength (these wavelengths may be shifted by subsequent processing of the recording material to “fix” the hologram). Alternatively a single wavelength may be used to write both the first and second images, one of the images being shifted by physical or chemical processing. For example a gel-based recording material may be pre-swollen in a humidity cabinet (preferably using steam, for speed), exposed, then dried to shrink the hologram, before recording the second image; alternatively the reverse of this procedure may be employed. In another method chemical processing may be used, for example, to add or remove material from the written hologram to change the fringe spacing, for example trapping material within a gel by polymer cross linking. Such techniques are well shown to the skilled person.

In some preferred embodiments of the method the hologram writing employs apparatus incorporating a spatial light modulator such as an LCD screen which modulates one of the two interfering light beams used to create the hologram. Such techniques are described in more detail in the applicant's co-pending application number PCT/GB2004/050014 filed 1 Oct. 2004 (with a priority date of 1 Oct. 2003), the contents of which are hereby incorporated in their entirety by reference.

In another aspect the invention provides hologram writing apparatus for creating a hologram, the apparatus comprising: an input to receive an initial image; an image partitioning system configured to partition said initial image into two spatially complementary regions defining respective first and second images which, when replayed together, give substantially the appearance of said initial image; and a writing system to write said first and second images into a single hologram such that they replay at respective first and second wavelengths, said first and second wavelengths being different to one another, to create said hologram.

The image partitioning system may comprise, for example, software running on a processor such as a digital sisal processor or running on a conventional PC, or dedicated optical or electronic hardware, or a combination of the two. In preferred embodiments the initial image is binarised to form the first and second images, the first image corresponding to a first portion of the initial image having a first binary value, and the second image corresponding to a second portion of the initial image having a second binary value. This may conveniently be achieved by processing an input image using, for example, a conventional library routine from a digital image processing software library to convert the initial image to a one-bit (per pixel) image, one of the first and second images then comprising this image and the other comprising an inverted version of this image (in which a binary 1 becomes a zero and vice-versa). Thus one of the first and second images may be viewed as a “positive” image and the other as a “negative” image.

In this specification it will be appreciated that references to light and optics include non-visible (infrared and ultraviolet light and optics).

These and other aspects of the invention will now be further described, by way of example only, with reference to the accompanying figures in which:

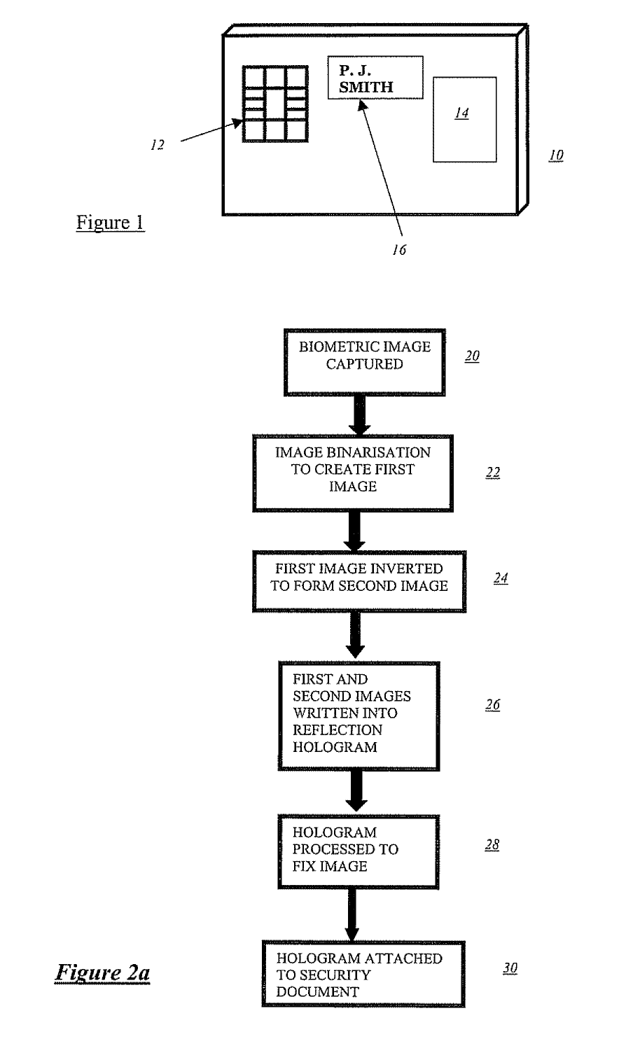

FIG. 1 shows a security document incorporating a biometric hologram according to an embodiment of one aspect of the present invention;

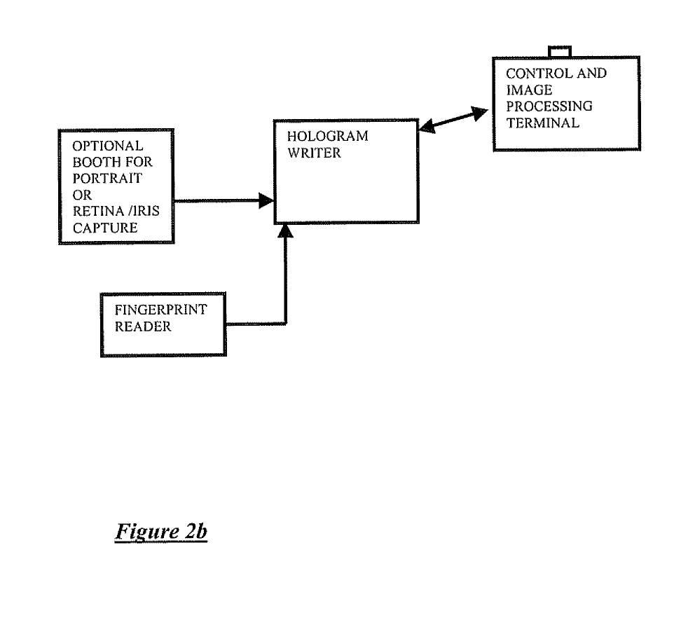

FIGS. 2a and 2b show, respectively, a flow diagram of a biometric hologram fabrication method according to an embodiment of another aspect of the present invention, and apparatus for implementing the method;

FIG. 3 shows a computer control system for the apparatus of FIG. 2b;

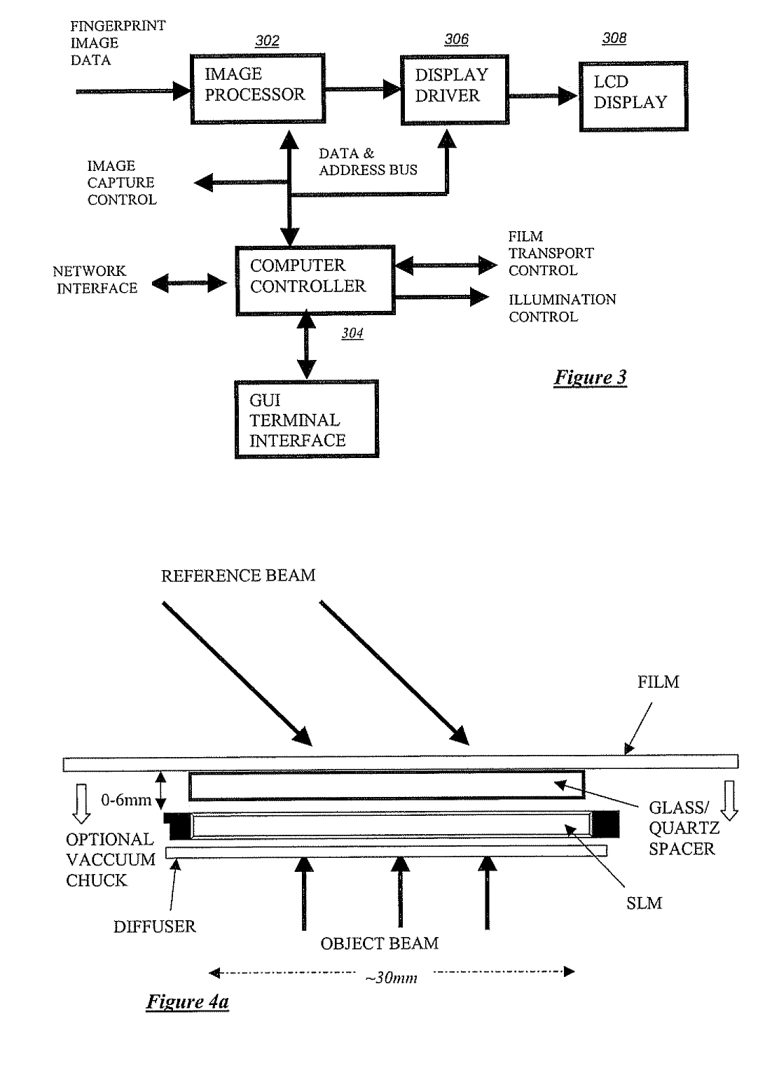

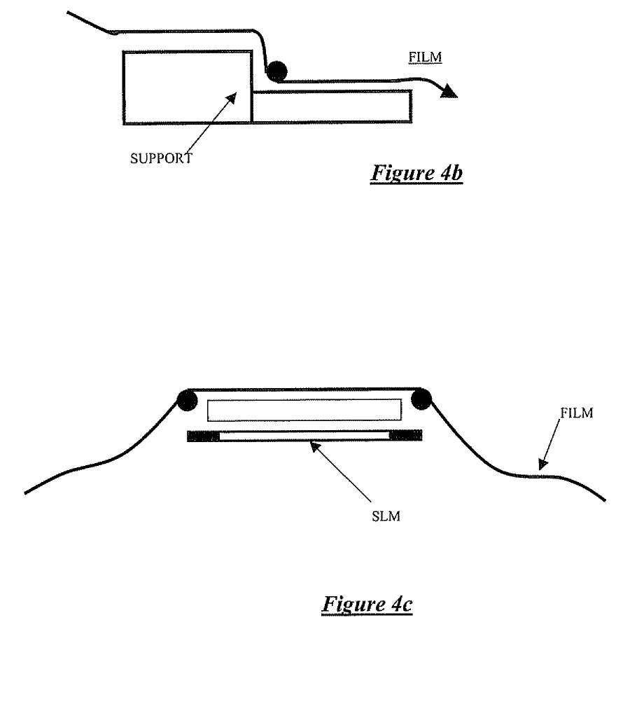

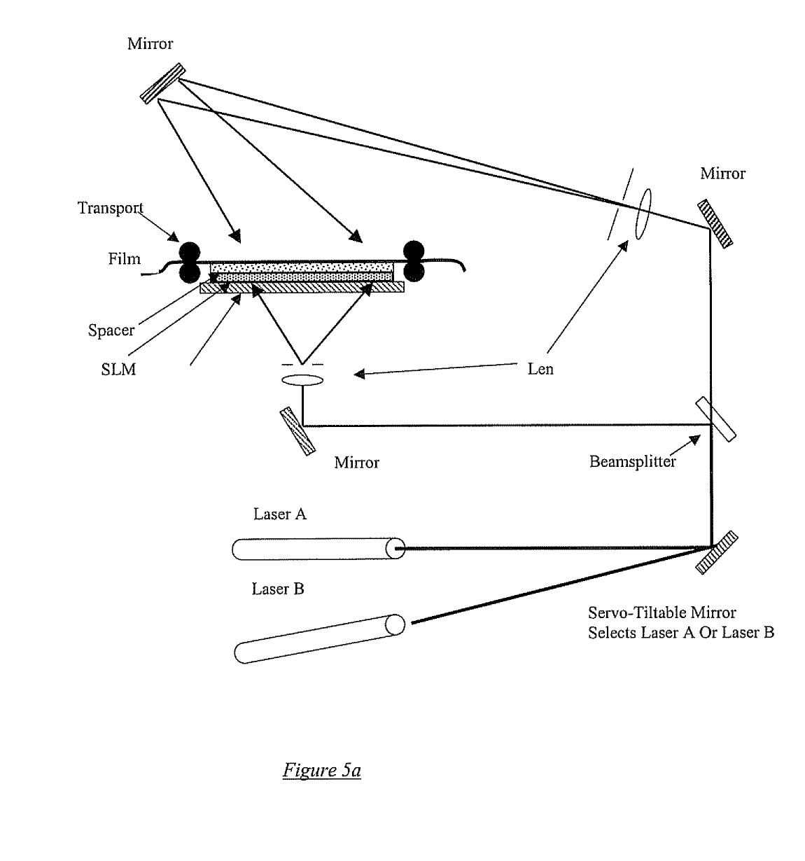

FIGS. 4a to 4c show details of a holographic writer and first and second alternative holographic film supports;

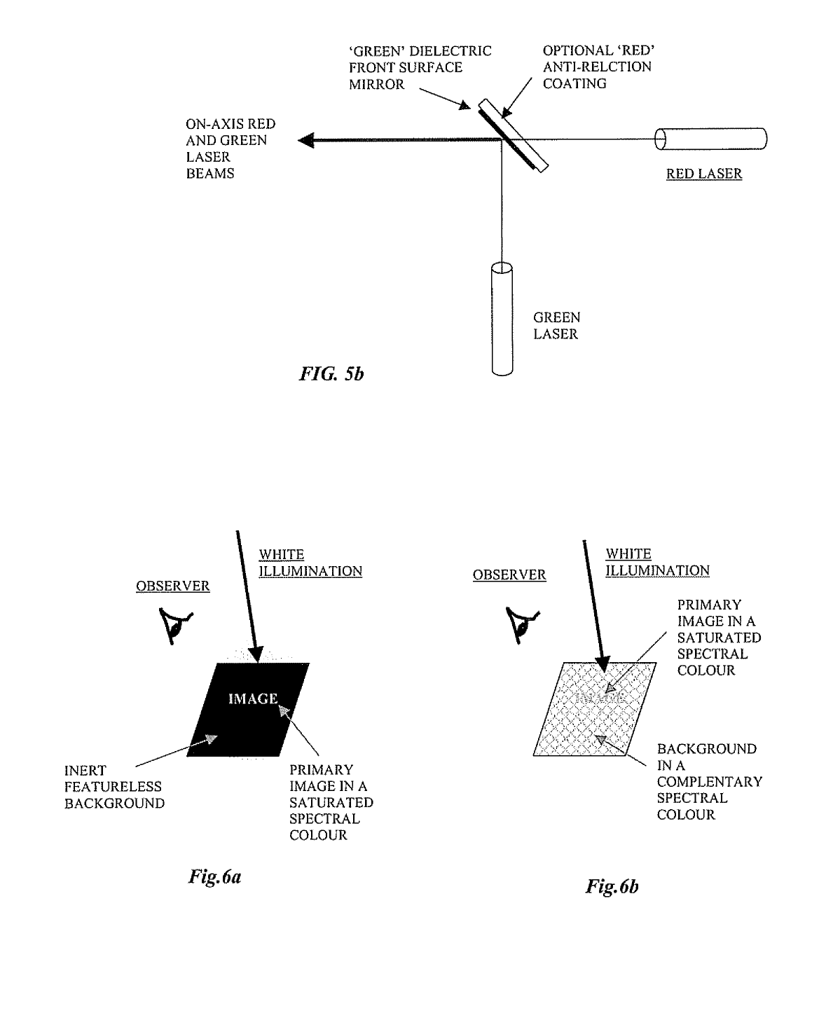

FIGS. 5a and 5b show schematic diagrams of optical arrangements for the apparatus of FIG. 2b; and

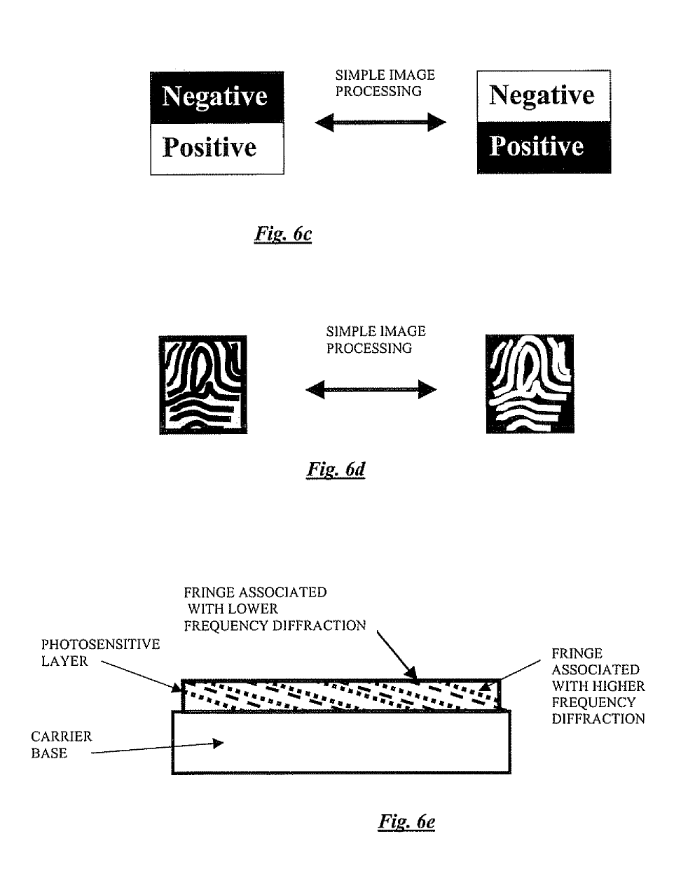

FIGS. 6a and 6b show details of examples of two-colour holograms according to embodiments of the present invention.

Referring to FIG. 1, a security document 10 comprises a hologram 14 storing biometric and other data and text 16 such as a name, address, national security number and the like. Optionally, depending upon the type of document (for example with, say a credit card) an integrated circuit memory chip 12 may also be included, as described in more detail in the Applicant's PCT/GB2004/050014 (ibid). Document 10 may comprise, for example, an identity card or document, driving license, passport, credit card or any other form of identification.

Referring to FIG. 2a a hologram for card 10 may be created by capturing biometric information such as a fingerprint (step 20), binarising this to create a first image (step 22), and inverting the binarised image to create a second image (step 24). Optionally other data may be created or input for storage with the hologram. At step 26 the first and second images are written into a reflective or reflection hologram, which is then processed in a conventional manner to fix the images (step 28), together with any additional data stored. The hologram is then attached to an identity document and covered with a protective layer (step 32).

FIG. 2b shows a holographic recording system. Data for recording with the hologram may be entered into the terminal and, optionally records such as write once read many (WORM) records are created locally and also, via a network, at a remote database for auditing and verification purposes. The film is preferably held securely within the hologram writer, for example accessed by a mechanical key, so that a secure film box can be removed from the writer and sent for secure chemical processing and incorporation into a document.

Referring next to FIG. 3, si shows a block diagram of a computer control system for the apparatus of FIG. 2a. Biometric data such as a fingerprint image is captured by commercial off the shelf equipment such as the BAC Securetouch USB2000 available from Bannerbridge plc of Basildon, UMK and provided to an image processor 302 which, under control of a control processor 304, provides an image to display driver 306 for display on an LCD display 308, for example at SVGA resolution, at a size of approximately 30 mm². The captured input image may be converted into a binarised image, and positive and negative versions of the image may be generated, either by image processor 302 or by control computer 304.

The size and resolution of the display may be determined based upon processing power and cost. The LCD display acts as a spatial light modulator as described below with reference to FIG. 4a and thus preferably allows illumination through the device. Typically such a display comprises a micrometer thick sheet of polarising material followed by electrically configurable liquid crystal material. The LCD display may be of a type which has permanently on or off pixels rather than pixels which are refreshed, for example a ferroelectric liquid crystal device so that the pixels stay in either an on or an off (black or white) state for the duration of the image recordal, typically around two seconds. Alternatively a conventional, raster scanned display may be employed. A suitable LCD display is available from Central Research Laboratories Ltd of London, UK, for example model SVGA2 monochrome transmission LCD. An LCD display without an in-built polariser may be employed with plane polarised laser illumination, which in effect provides approximately 50% more light.

The positive and negative images are preferably recorded using different coloured lasers. Other means of creating the two different colours in the hologram include chemical or physical expansion of the film layer prior to exposure, and adjustment of the final thickness of the hologram layer during chemical processing of the film. For example the developer and bleaching solution for silver halide materials may be designed/selected to produce the desired colours in the final image. The layer properties of the selected recording film also affect the colour reconstruction of the stored images.

The hologram recording medium may comprise any conventional hologram recording medium including, but not limited to, dichromated gelatine (DCG), silver halide, and photo polymer based materials.

Referring next to FIG. 4a this shows an optical configuration of the spatial light modulator and film. The spatial light modulator may be substantially adjacent the film or may be spaced apart from the film by a glass or quartz spacer. Spacers of 2, 4 or 6 mm may be employed, optionally mechanically selectable on the control of the computer controller 304 in order to record images at different planes within the hologram. The maximum adjustment of the spacing between the spatial light modulator and film is determined by the coherence length of the laser, and is typically a few mm to a few cm (say in the range 1 mm to 30 mm, possibly up to 100 mm) for a diode laser (since, as shown later in FIG. 5, optical path lengths from the laser for the object and reference beams are preferably substantially matched).

Preferably the arrangement includes a diffuser prior to the spatial light modulator comprising, for example, ground glass or substantially non-birefringent plastic material such as polycarbonate or polyester film. Such diffusers are available from Lee Filters in the UK. The diffuser permits recording of the hologram since the differences in optical path lengths to the film from diffused rays originating from a point on the diffuser is very small, but the diffuser has the effect of providing a hologram with a speckle pattern rather than a so-called shadowgram which appears shiny like a mirror.

Many mechanical schemes may be employed for holding the film in close proximity to the spatial light modulator or spacer depending, for example, on whether sheet fed or roll fed film is employed. FIGS. 4b and 4c show two examples of film transport mechanisms; for sheet film a sheet feeder may be employed; optionally a vacuum chuck may also be used to ensure the holographic recording material bears against the spatial light modulator or spacer. In a less preferred arrangement a mounting frame holds the SLM and/or spacer in a fixed or controllable spatial relationship with respect to the film. In any of the above arrangements index matching or interface coupling temporary adhesive may be employed if necessary.

FIG. 5a shows one example of an optical configuration for the apparatus of FIG. 2b. In particular this optical configuration shows how either laser A (say, red, for example Krypton 647 nm or HeNe 633 nm) or laser B (say, green, for example Argon 514 nm) may be selected for recording the respective first and second stored images in a volume reflection hologram, by tilting a mirror between two alternative positions, for example under servo control. In this way two different images can be recorded, each with a different colour, but both in substantially the same plane (when replayed) with reference to the plane of the recording material.

An alternative way to achieve this interchange of laser illumination is to use a wavelength specific dielectric mirror such that one laser beam is transmitted almost without attenuation, whilst another colour is incident at an angle suitable to achieve reflection on axis with the transmitted beam. This particular embodiment facilitates use of a colour SLM and simultaneous exposure to a multiple-wavelength reference illumination so as to allow simultaneous recording of the two image colours.

FIG. 5b shows each an alternative way to achieve the interchange of laser colour illumination. A wavelength specific dielectric coating or mirror is produced on a glass substrate. The thickness of this substrate may be wedged in some applications to improve performance of the device as regards internal reflection and fringing of the throughput laser beam. Furthermore the glass may be coated on the rear surface with an anti-reflection layer so as to avoid reflection of the incident laser beam. The laser beam incident on the front surface is reflected precisely on axis with the transmitted laser beam. The two laser beams can then be manipulated as a single entity in the optical system and may be spatially filtered at a single station, for example using a lens and pinhole aperture.

This particular configuration is compatible with the use of a colour SLM system and thus simultaneous exposure of two image colour components in the recording medium, which is helpful for certain embodiments of the current method. A single exposure and settling period can have advantages over the consecutive exposure of the two individual channels of colour information. Part of the recorded image, for example, at a certain reference illumination angle may thus embody the current technique, whereas another feature may be represented in mixed colour, or in a single colour, in either the same surface zone or in a spatially separated area of the hologram surface. For example, a ‘vignette’ or a top/bottom divide could separate the two components.

In FIGS. 6a and 6b, holograms are represented where a single primary image is shown in FIG. 6a contrasted principally by its tonality against a black or ‘absent’ backdrop. In FIG. 6b the same image is contrasted not by tonal brightness, but by the use of two spectrally pure colours of full brightness, which have a complementary qualities that provide an interesting visual experience for the viewer. Typically these complementary pairs of colours could be red/green or blue/yellow.

FIG. 6c shows the simple image processing which gives rise to the technique. Commonly available graphics software is able to tonally invert an image to provide a pair of component images. These images can then be displayed consecutively upon a black and white LCD in the form shown and imaged into holograms in the appropriate colours. Alternatively, the processed information could be converted in software to the appropriate laser colours and displayed on a colour LCD for imaging with a single exposure by a twin laser exposure system previously described.

In principle it is possible that the method could be applied to a tertiary separation of certain suitable images. For example a fingerprint image could be divided into three populations or sets of genes, for example the ridges, grooves and surrounding non-imaged area could be formed into the three colour components. One of these components could for example be imaged with a third laser or by a mixed beam from two lasers to provide a third colour in the final hologram.

FIG. 6d shows a fingerprint image processed in such a way as to enable its image to be recorded in hologram form in one of the main embodiments of this technique. As described before this image is sent to a spatial light modulator in order to facilitate its transfer into the form of a dual colour hologram.

FIG. 6c represents a typical holographic recording medium a thick carrier base of say 80 microns. Within the photosensitive layer of thickness say 8 microns, are two populations of fringes in the form of refractive index modulation of the layer. These individual microstructures can exist within the same layer, and whilst their existence is somewhat mutually deleterious, they are nevertheless able to co-exist and provide high diffraction efficiency when illuminated at the appropriate angle by an incident white light reconstruction beam. Furthermore, this diffraction is selective towards two particular wavelengths, and monochromatic LED's of the appropriate colour may selectively reconstruct these images either consecutively or simultaneously, to facilitate the specific recognition process.

In addition to the previously described aesthetic advantages of the hologram, the method also has additional advantages as a security device.

Advantageously, the spectrally contrasting pair of colours selected provide a visually interesting effect to attract the attention of an observer, as well as providing an attractive substitute for the tonal contrast normally expected from a primary image, standing against a routine black or neutral background fill. Thus the reputation of holography as an interesting visual medium is enhanced and provides an advantage over alternative data storage media, which may not have such a visual quality.

When viewed by an electronic detection system however, the colour component images contained in the hologram have an intrinsic relationship, which is defined by a simple inversion and thus automatically provide additional verification data. By illuminating these complementary images with alternating monochromatic light of the appropriate colours, it is possible to take advantage of their inverse relationship by simple graphical software inversion, such that a secondary comparison between the two components allows an additional opportunity to distinguish any counterfeit version.

A counterfeit attempt may, for example, be incorrectly balanced between the relative ‘weights’ of the twin image components. It may, for example, contain one image in a colour which is of approximately the correct wavelength, whilst the other colour may be less accurately tuned to the original requirement, and may therefore provide a low or absent signal to the camera in the detector, due to its mismatch with the monochromatic illuminating source. Thus we are compounding the difficulty which will be experienced by any unscrupulous attempt to produce a device which will pass as an authorised security device. Moreover, one of the selected colours for another embodiment of the technique may be outside the visible spectrum. The actual image detail for which the detection system is searching in certain applications might be invisible to the human eye and may be of a covert nature; it may be masked by the ‘secondary’ image which is overt, attractive and thus is receipt of prime attention by the general public and the untrained observer, but of only secondary interest to the machine read system.

The nominal use of ultra-violet and infra red colour components has been suggested in numerous applications of embossed holography security devices. However, by virtue of the principle of the Benton or Rainbow Hologram, it follows that in may cases the tilting of the hologram device will result in a swing of wavelength towards the visible and tend to reveal ‘hidden imagery’.

In volume reflection holograms, however, there is little shift of colour associated with tilting the hologram, and as a result a covert image is more likely to remain unseen by the unauthorised viewer. Additionally, the use of colours at the blue end of the spectrum is difficult in surface-relief holography since the embossing process is not readily compatible with fringe frequencies associated with microstructures of dimensions smaller than 0.5 microns, due to limitations in the resolution capabilities of the materials and machinery.

No doubt many other effective alternatives will occur to the skilled person and it will be understood that the invention is not limited to the described embodiments but encompasses modifications apparent to those skilled in the art lying within the spirit and scope of the claims appended hereto.

1-18. (canceled)

19. A hologram storing a pair of images, the hologram comprising:
a first stored image configured to replay at a first wavelength; and
a second stored image configured to replay at a second wavelength different to said first wavelength; and
wherein said first and second stored images are spatially complementary such that when replayed they appear together, substantially in register, and give the appearance of a singles substantially uninterrupted image.

20. A hologram as claimed in claim 19 wherein said first and second images are configured such that when replayed a region not occupied by said first image is occupied by said second image and vice-versa.

21. A hologram as claimed in claim 19 wherein said first and second images are both substantially planar and are configured such that when replayed they occupy substantially the same plane.

22. A hologram as claimed in claim 19 wherein said first and second images are configured such that when replayed there is substantially, no angular separation between them.

23. A hologram as claimed in claim 19 wherein said first and second wavelengths define different visually distinguishable colours.

24. A hologram as claimed in claim 19 wherein said single substantially uninterrupted image comprises a biometric image: in particular a fingerprint.

25. A hologram as claimed in claim 19 wherein said single substantially uninterrupted image comprises a binarised image having regions of a first binary value defined by said first mage and regions of a second binary value defined by said second image.

26. A hologram as claimed in claim 19 wherein said hologram comprises a volume refection hologram.

27. A method of creating a hologram, the method comprising:
receiving an initial image;
partitioning said initial image into two spatially complementary regions defining respective first and second images which when displayed together, give substantially the appearance of said initial image; and
writing said first and second images into a single hologram such that they replay at respective first and second wavelengths, said first and second wavelengths being different to one another to create said hologram.

28. A method as claimed in claim 27 wherein said writing comprises writing said first image into said hologram at a third wavelength and writing said second image into said hologram at a fourth wavelength, said third and fourth wavelengths being different to one another.

29. A method as claimed in claim 27 wherein said writing includes a processing stage processing said hologram to shift a wavelength of one of said first and second images from a writing wavelength to a replay wavelength different to said writing wavelength.

30. A method as claimed in claim 27 wherein said writing comprises modulating a reference light beam with said first and second images using a spatial light modulator to create interference patterns for said first and second images in said hologram.

31. A method as claimed in claim 27 wherein said writing comprises direct writing of one or both of said first and second images into said hologram.

32. A method as claimed in claim 27 wherein said partitioning comprises binarising said initial image to form said first and second images, wherein said first image corresponds to a first portion of said initial image having a first binary value, and wherein said second image corresponds to a second portion of said initial image having a second binary, value.

33. A method as claimed in claim 27 wherein said hologram comprises a volume reflection hologram.

34. A method as claimed in claim 27 wherein said initial image defines a fingerprint.

35. A method as claimed in claim 27 wherein said first and second wavelengths define visually distinguishable colours.

36. Hologram writing apparatus for creating a hologram, the apparatus comprising:
an input to receive an initial image;
an image partitioning system configured to partition said initial image into two spatially complementary regions defining respective first and second images which, when replayed together, give substantially the appearance of said initial image; and
a writing system to write said first and second images into a single hologram such that they replay at respective first and second wavelengths: said first and second wavelengths being different to one another, to create said hologram.
